(19) United States
(12) Patent Application Publication
(10) Pub. No.: US 2002/0157007 A1
(43) Pub. Date: Oct. 24, 2002

(54) User authentication system and user authentication method used therefor

(75) Inventor: Toshiyuki Sashihara, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/119,946

(22) Filed: Apr. 11, 2002

(30) Foreign Application Priority Data
Apr. 18, 2001 (JP) 2001-118972

(51) Int. Cl. H04L 9/00

(52) U.S. Cl. 713/183; 713/168

(57) ABSTRACT

An object of the invention is to provide an access-point user authentication system which can implement a safer authentication scheme with an interface easy to use for general users. When the user of an unauthenticated terminal sends a packet to a wireless network and a wireless communications section in the access point receives the packet, a controller checks with reference to an authentication result storage means whether access by the user is permitted and passes the IP packet to a wired communications section to transmit it to the wired network if access is permitted, but discards the received packet if access is not permitted. If the controller verifies that the packet from the terminal contains the HTTP GET method, CGI execution means generates an HTML document for entering a user ID and password and sends it to the terminal via the wireless communications section.

### BACKGROUND OF THE INVENTION

1. Field of the Invention

The present invention relates to a user authentication system and user authentication method used for it. More particularly, it relates to a user authentication system used at an access point of a wireless LAN (Local Area Network) system.

2. Description of the Prior Art

Recently, with decreasing prices, wireless LAN systems have been increasingly used in companies and households. A wireless LAN system generally consists of terminals 51A to 51C, an access point 52, and a wire communications medium 500, as shown in FIG. 10.

Generally, the terminals 51A to 51C which are used at a wireless LAN environment are notebook-type personal computers equipped with a wireless LAN card. The access point 52 is a node connected to the wire communications medium 500 and serves as an entrance to a wired segment for the terminals 51A to 51C which are used at the wireless LAN.

Therefore, by conducting wireless communications with the access point 52, the terminals 51A to 51C can access the network in the wired segment consisting of the wire communications medium 500. Generally, a 10BASE-T cable is often used as the wire communications medium 500.

Since the terminals 51A to 51C and the access point 52 communicate by radio, the number of users who are allowed to access is not limited by the number of connectors unlike in the case of wired communications. Thus, if the access point 52 transferred incoming packets unconditionally, the result would be that anyone who is within the coverage area of the access point 52 could access the wired segment.

Generally, the access point 52 is provided with a filtering function for allowing passage of only the packets related to the terminals 51A to 51C which are permitted to access to the wired segment.

Currently, the access point 52 of wireless LAN systems performs filtering by using MAC (Media Access Control) addresses, i.e., the data-link layer addresses of the terminals 51A to 51C

Specifically, upon receiving a packet from one of the terminals 51A to 51C, the access point 52 extracts the source MAC address from the header of the packet, and with reference to a preset authentication table, checks whether the owner of the source MAC address is permitted to access to the wired segment. Then, if access is permitted, the access point 52 allows passage of the packet. Otherwise, it discards the packet.

Although the conventional wireless LAN system described above uses the MAC address for authentication, MAC addresses of terminals can be found out easily. An authentication system using the MAC address should treat it as a secret key so that third parties cannot find it out.

However, the MAC address is not intended to be used for authentication and can be learned easily by using a tool included in an operating system. Therefore, any third party can access the wired segment by stealing the MAC address of an authorized terminal and sending it from another terminal.

To solve this problem, a method called WEP (Wired Equipment Privacy) is available. This method offers encrypted communications using a secret key shared between an access point and terminal. If a third party who does not know the secret key attempts to communicate, no communication can be established because the access point and terminal cannot decrypt the signals transmitted by each other.

Thus, with the WEP method, denial of access shows up only in an inability to communicate rather than being indicated explicitly. Consequently, if communication cannot be established, there is no way for the user to tell definitely whether it is due to denial of access or degradation in the wireless communications environment.

Such ambiguous authentication is not desirable in the case of coffee shops and restaurants which provide wireless communications services to many and unspecific persons. It is desirable to explicitly indicate whether authentication has succeeded or failed. To indicate success or failure of authentication explicitly, it is necessary to establish communication at least between the access point and terminal, even with a third party, and WEP-based authentication is not suitable for this purpose.

As an alternative to MAC address-based authentication, there is a demand for an authentication scheme which will allow even a third party terminal to communicate with an access point for the purpose of authentication, will return the result of authentication to the terminal, and can be implemented with a user interface easy enough to use for many and unspecific persons for whom wireless communications services are intended.

### BRIEF SUMMARY OF THE INVENTION

Therefore, the object of the present invention is to solve the above problem by providing a user authentication system and user authentication method therefor which can implement a safer authentication scheme with an interface easy to use for general users.

The present invention provides a user authentication system containing an access point which serves as an entrance to a wired network for terminals which use a wireless network, wherein the above described access point comprises: determining means for determining whether a given one of the above described terminals is permitted to access to the above described wired network when a packet is received from the above described terminal; means for transmitting the packet to the above described wired network if the above described determining means determines that the above described access is permitted; means for discarding the packet if the above described determining means determines that the above described access is not permitted; and means for generating an HTML (Hypertext Markup Language) document for user identification information and password entry and transmitting it to the above described terminal when a request for an authentication page is received from the above described terminal.

The present invention provides a user authentication method for a network containing an access point which serves as an entrance to a wired network for terminals which use a wireless network, comprising, in the above described access point: a step of determining whether a given one of the above described terminals is permitted to access to the above described wired network when a packet is received from the above described terminal; a step of transmitting the packet to the above described wired network if it is determined that the above described access is permitted; a step of discarding the packet if it is determined that the above described access is not permitted; and a step of generating an HTML (Hypertext Markup Language) document for user identification information and password entry and transmitting it to the above described terminal when a request for an authentication page is received from the above described terminal.

Thus, the access-point user authentication method according to the present invention provides a technique which can implement a safer authentication scheme with an interface easy to use for general users, at an access-point installed at the boundary between a wired network and wireless network.

More particularly, according to the access-point user authentication method of the present invention, when the user of an unauthenticated terminal sends a packet to a wireless network and a wireless communications section in the access-point receives the packet, a controller checks with reference to an authentication result storage whether access by the user is permitted and passes the IP packet to a wired communications section to transmit it to the wired network if it is determined that the access is permitted, but discards the packet if it is determined that the access is not permitted.

Then, if the user of the unauthenticated terminal sends an IP packet which contains the HTTP (Hypertext Transfer Protocol) GET method and whose destination port number is 80 to the wireless network, by using a WEB browser or the like, the access point receives the packet by means of the wireless communications section and passes it to the controller. After verifying that the destination port number is 80 and that the HTTP GET method is contained, the controller asks CGI (Common Gateway Interface) execution means to execute an authentication CGI program.

The CGI execution means generates an HTML (Hypertext Markup Language) document for entering a user ID and password and sends it to the terminal via the wireless communications section. Consequently, a page appears on the WEB browser of the terminal, prompting the user to enter his/her user ID and password.

When the user of the unauthenticated terminal enter his/her user ID and password and sends them to the wireless network, the access point receives them by means of the wireless communications section and passes them to the controller. After verifying that the destination port number of the received packet is 80, the controller passes the data of the received packet to the CGI execution means.

After verifying that the user ID and password are contained, the CGI execution means passes them to an authentication client, which then asks an authentication server whether the given user is permitted to access to the wired network.

When the result of authentication check is obtained, the authentication client writes it into authentication check result storage means and passes it to the CGI execution means. Based on the received authentication check result, the CGI execution means generates an HTML document which contains the result and sends it to the terminal via the wireless communications section. Consequently, the result of the authentication check is displayed on the WEB browser of the terminal.

The above procedures allow a safer authentication scheme to be implemented with an interface easy to use for general users. Specifically, in a wireless communications environment such as a wireless LAN, they make it possible to implement safe authentication using a password which the user can specify freely. Although MAC address-based authentication schemes which are used generally at present are not safe because any third party can decipher MAC addresses and falsify transmitted packets, the method according to the present invention is safe as long as the user does not disclose his/her password to others.

Also, although with the WEP-based authentication described above, denial of access is indicated indistinctly as an inability to communicate, with the method according to the present invention, the access point can explicitly declare “access denied” and the result of authentication check is returned to the terminal because even a packet from a terminal which is not permitted to access reaches the access point.

Besides, the access point contains an HTTP protocol interpreter and HTML document generating means. Therefore, by using a popular WEB browser for user ID and password entry, it is possible to implement a user authentication system with an interface easy to use for general users.

Furthermore, when the HTTP GET method is received from an unauthenticated user, the access point returns an HTML document for authentication instead of the HTML document requested by the user. Thus, when using the WEB browser, the user does not need to be aware of whether he/she has been authenticated.

### BRIEF DESCRIPTION OF THE DRAWINGS

FIG. 1 is a block diagram showing a network configuration according to one embodiment of the present invention;

FIG. 2 is a block diagram showing detailed configuration of the access point shown in FIG. 1;

FIGS. 3 is a flowchart of operations performed when a packet is received by the wireless communications section in FIG. 2;

FIG. 4 is a flowchart of operations performed when a packet is received by the wireless communications section in FIG. 2;

FIG. 5 is a flowchart of operations performed when a packet is received by the wired communications section in FIG. 2;

FIG. 6 is a flowchart of operations performed when a packet is received by the wired communications section in FIG. 2;

FIG. 7 is a sequential chart showing the operation of a user authentication system according to the first embodiment of the present invention;

FIG. 8 is a diagram showing the configuration of an authentication table in the authentication check result storage means shown in FIG. 2;

FIG. 9 is a block diagram showing the configuration of an access point according to another embodiment of the present invention; and

FIG. 10 is a block diagram showing a conventional network configuration.

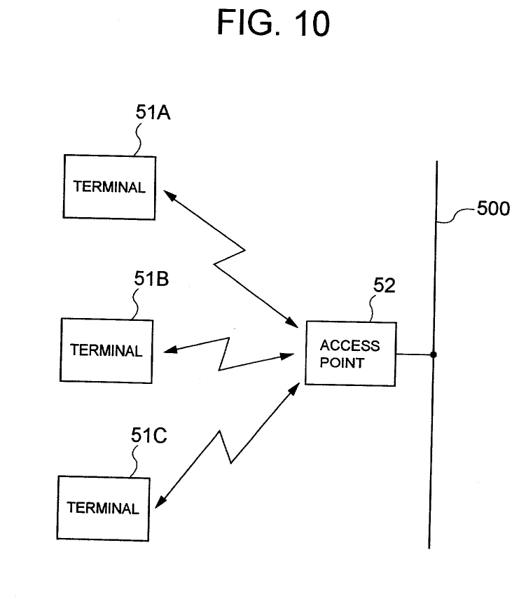

### DETAILED DESCRIPTION OF THE PREFERRED EMBODIMENTS

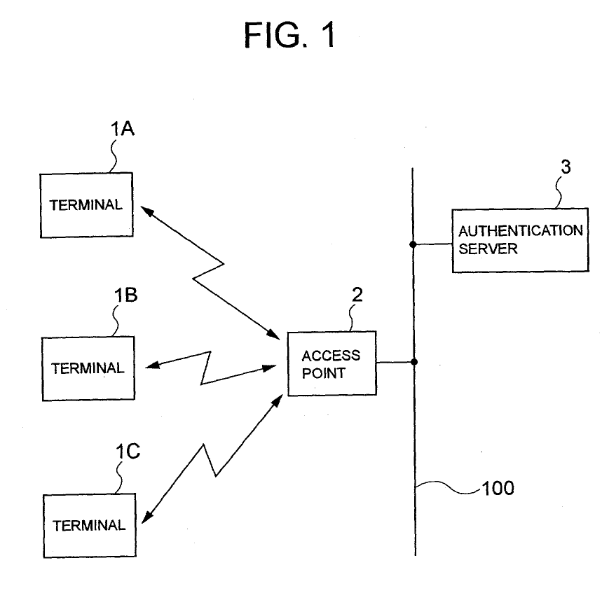

Now, embodiments of the present invention will be described with reference to the drawings. FIG. 1 is a block diagram showing a network configuration according to one embodiment of the present invention. In FIG. 1, the network according to the first embodiment of the present invention consists of terminals 1A to 1C, an access point 2, a wire communications medium 100, and an authentication server 3.

The terminals 1A to 1C communicate with a wired network through wireless communications with the access point 2. They are, for example, notebook-type personal computers equipped with a wireless LAN (Local Area Network) card.

If a packet is received from any of the terminals 1A to 1C, the access point 2, which is connected to the wire communications medium 100, checks whether the terminal which sent the packet is permitted to access the wired network. If the terminal is permitted to access, the access point 2 transfers the received packet to the wire communications medium 100. Otherwise, it discards the received packet. Besides, it is assumed that the access point 2 has been assigned an IP (Internet Protocol) address.

The wire communications medium 100 consists of a 10BASE-T cable, for example. The authentication server 3 is designed to respond to any inquiry from the access point 2 as to whether a user is permitted to access the wired network.

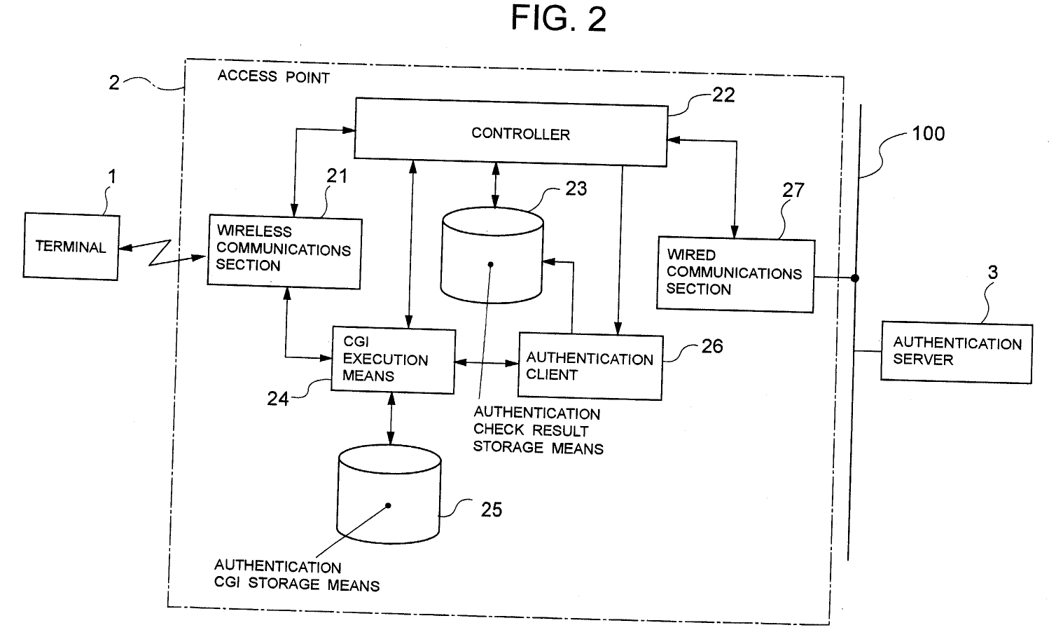

FIG. 2 is a block diagram showing detailed configuration of the access point 2 shown in FIG. 1. In FIG. 2, the access point 2 consists of a wireless communications section 21, controller 22, authentication check result storage means 23, CGI (Common Gateway Interface) execution means 24, authentication CGI storage means 25, authentication client 26, and wired communications section 27.

The wireless communications section 21 performs modulation and demodulation, based on the IEEE 802.11b or Bluetooth standard, for example. The controller 22 serves to filter the packets received by the wireless communications section 21 and wired communications section 27, using information stored in the authentication check result storage means 23. The authentication check result storage means 23 stores information necessary for the controller 22 to filter packets.

The CGI execution means 24 executes a CGI program stored in the authentication CGI storage means 25, which stores a CGI program for generating an HTML (Hypertext Markup Language) document needed in the process of authentication. Incidentally, programs written in another scripting language [such as ASP (Active Server Pages) or Servlet] may be used instead of the CGI program.

The authentication client 26 serves to inquire of the authentication server 3 whether a user is permitted to access to the wired network based on a request from the CGI execution means 24, and then write the result in the authentication check result storage means 23 and notify the CGI execution means 24 of the result.

The wired communications section 27 performs processing based on a data-link layer protocol used for transmission over the wire communications medium 100. For example, if Ethernet is used as a physical layer/data-link layer protocol, the wired communications section 27 performs processes such as generation of Ethernet frames and CSMA/CD (Carrier Sense Multiple Access with Collision Detection) processes.

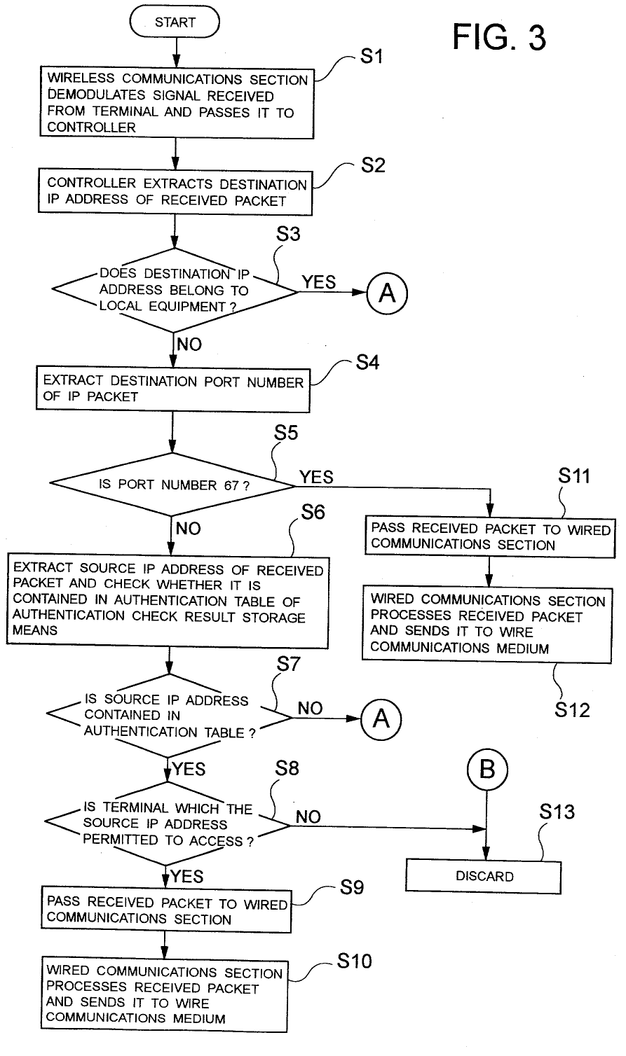

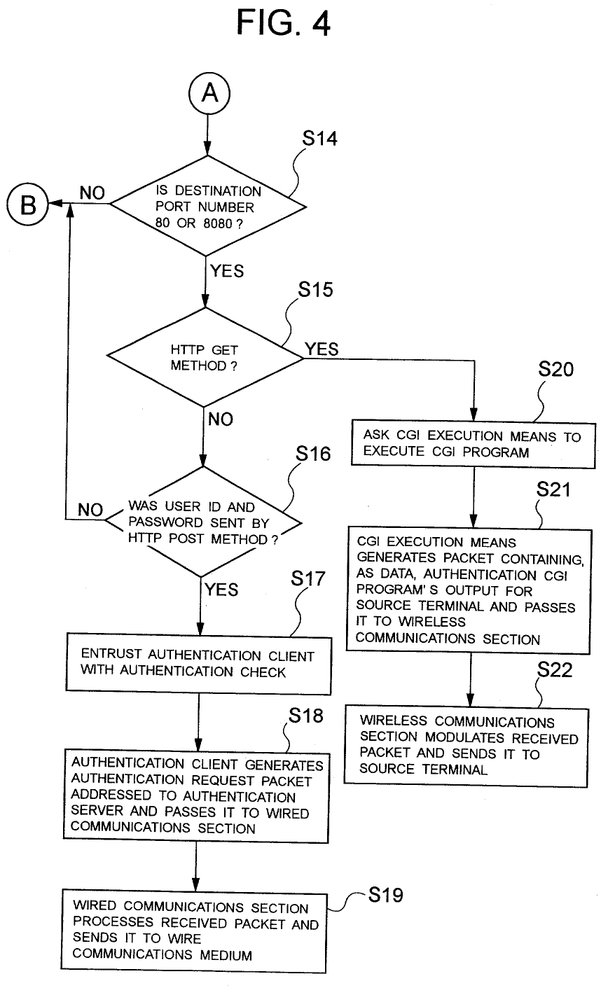

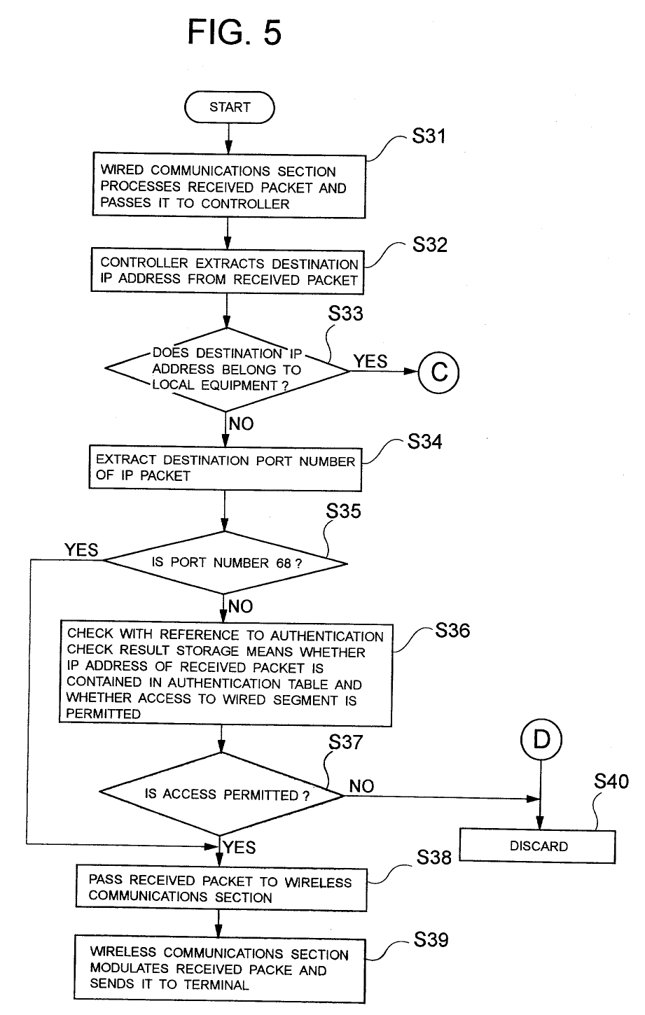

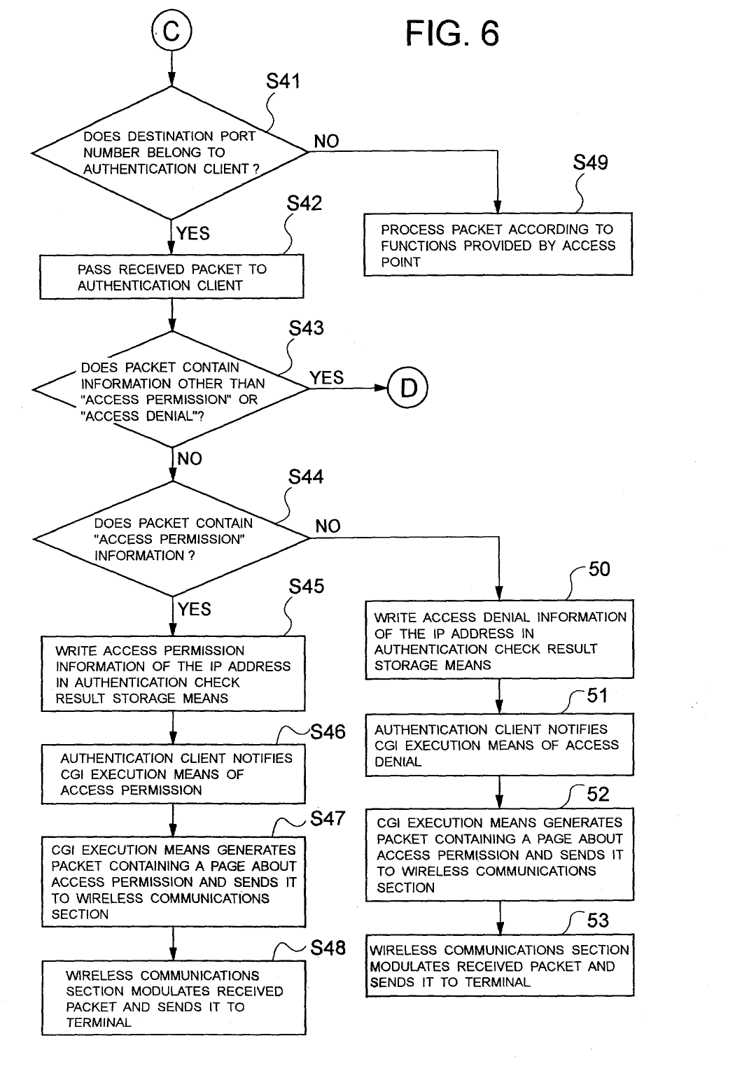

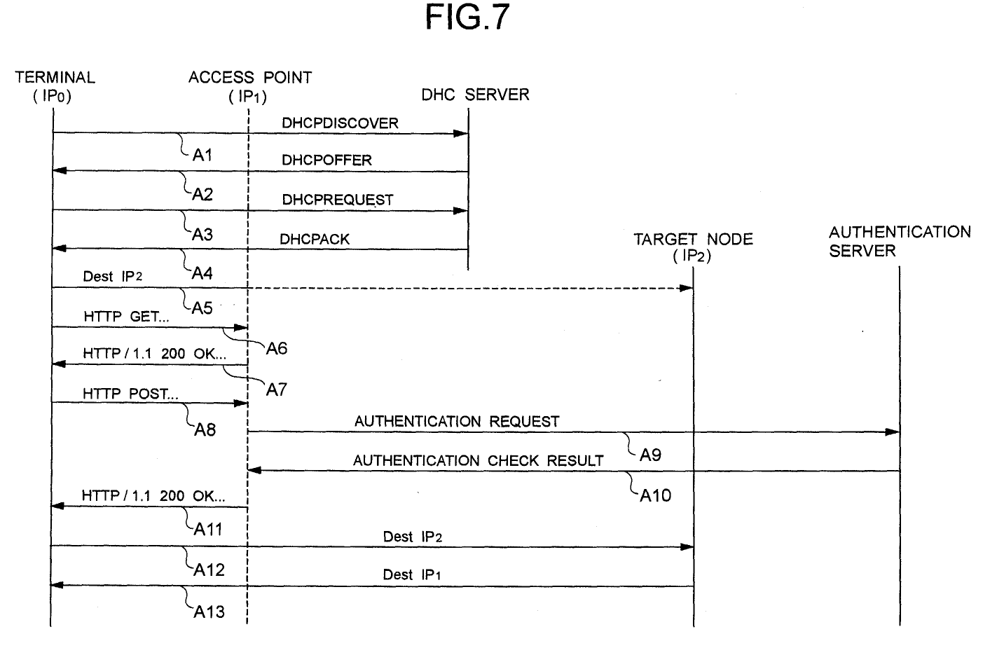

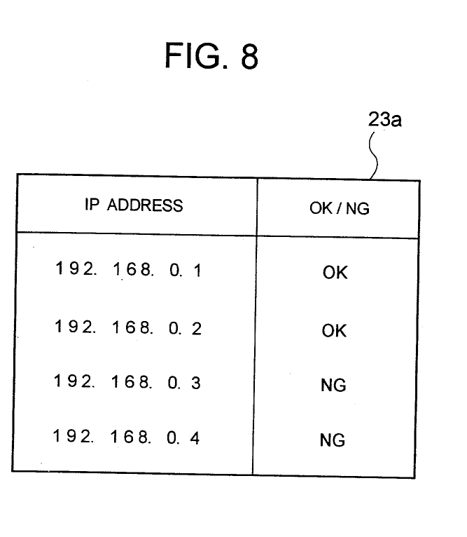

FIGS. 3 and 4 are a flowchart of operations performed when a packet is received by the wireless communications section 21 in FIG. 2, FIGS. 5 and 6 are a flowchart of operations performed when a packet is received by the wired communications section 27 in FIG. 2, FIG. 7 is a sequential chart showing the operation of the user authentication system according to the first embodiment of the present invention, and FIG. 8 is a diagram showing the configuration of an authentication table in the authentication check result storage means 23 shown in FIG. 2. The operation of the user authentication system according to the first embodiment of the present invention will be described with reference to FIG. 2 to FIG. 8.

First, the operation of the access point 2 will be described with reference to the sequence shown in FIG. 7. According to this embodiment, IEEE 802.11b employed for wireless LANs is used as the physical layer/data-link layer protocol between a terminal 1 and the access point 2 while Ethernet is used as the physical layer/data-link layer protocol over the wire communications medium 100. Also, TCP/IP (Transmission Control Protocol/Internet Protocol) is used as the network layer/transport layer protocol for the entire network including the wireless segment and wired segment.

First, when the terminal 1 starts to use the network, since it does not have an IP address, it tries to acquire an IP address from a DHCP (Dynamic Host Configuration Protocol) server. At this time, the terminal 1 broadcasts a packet (DHCPDISCOVER) A1. Upon receiving the packet (DHCPDISCOVER) A1, the DHCP server returns a packet (DHCPOFFER) A2 which carries an IP address to be assigned.

Upon receiving the packet (DHCPOFFER) A2, the terminal 1 sends out a packet (DHCPREQUEST) A3, indicating that it will accept the offered IP address. Upon receiving the packet (DHCPREQUEST) A3, the DHCP server acknowledges the acceptance by sending a packet (DHCPACK) A4. If the terminal 1 has been preassigned a fixed IP address, the above-mentioned sequence for sending and receiving the packets A1 to A4 does not exist.

The terminal 1 sends a packet A5 to a node whose IP address is IP₂. If there is no response to the packet A5, the user of the terminal 1 learns that the terminal 1 is unauthenticated, and issues the HTTP (Hypertext Transfer Protocol) GET method A6 to the access point 2 whose IP address is IP₁, by using a WEB browser.

In response to the request, the access point 2 returns an authentication page (HTTP/1.1 200 OK . . . ) A7. This authentication page contains fields for user ID and password entry and a send button for sending entered user ID and password. As the user of the terminal 1 enters his/her user ID and password and presses the Send button, the Web browser sends the user ID and password by using the HTTP POST method A8.

The user ID and password to be transmitted may be encrypted by SSL (Secure Socket Layer). In that case, the access point 2 should be provided with a part for SSL processing.

Upon receiving the user ID and password, the access point 2 sends out an authentication request packet A9 containing the user ID and password to the authentication server 3. The authentication server 3 runs an authentication check based on the received user ID and password, and sends a packet A10 containing the result of the authentication check to the access point 2. In this example, it is assumed that the authentication check verifies that the user is permitted to access to the wired network.

Upon receiving the result of the authentication check, the access point 2 sends an authentication check result (HTTP/1.1 200 OK . . . ) All which indicates access permission to the terminal 1. After access has been permitted, the terminal 1 sends a packet (Dest IP₂) A12 to the target node whose IP address is IP₂. Then the target node sends a packet (Dest IP₁) A13 to the terminal 1.

Now the operation of the access point 2 will be described with reference to FIGS. 3 to 6. As the terminal 1 sends out the packet A1 shown in FIG. 7, the wireless communications section 21 of the access point 2 receives the signal sent from the terminal 1, demodulates it, takes out an IEEE 802.11b frame and extracts the IP packet as data from the IEEE 802.11b frame, and passes it to the controller 22 (Step S1 in FIG. 3).

The controller 22 extracts the destination IP address from the header of the IP packet (Step S2 in FIG. 3) and checks whether the destination IP address matches the IP address assigned to the access point (Step S3 in FIG. 3). In this example, the IP packet is a DHCPDISCOVER packet, and thus its destination is a broadcast address (255. 255. 255. 255), which does not match the IP address of the access point. Consequently, the controller 22 extracts the port number of the received IP packet (Step S4 in FIG. 3).

Next, the controller 22 checks whether the extracted port number is “67” (Step S5 in FIG. 3), which is a port number reserved for the DHCP server. Since the destination port of the DHCPDISCOVER packet is “67,” the received IP packet is passed to the wired communications section 27 (Step S11 in FIG. 3). That is, DHCP-related packets are not filtered. The wired communications section 27 stores the received IP packet as Ethernet frame data, and sends it out as an Ethernet frame to the wire communications medium 100 (a 10BASE-T cable, in this example).

Next, the operations performed by the access point 2 when it receives the packet A2 will be described with reference to FIG. 5. When the wired communications section 27 of the access point 2 receives an Ethernet frame, it passes the IP packet stored as Ethernet frame data to the controller 22 (Step S31 in FIG. 5)

Upon receiving the IP packet, the controller 22 extracts the destination IP address (Step S32 in FIG. 5) of the received packet and checks whether the destination IP address matches the IP address assigned to the local equipment (the access point 2) (Step S33 in FIG. 5). In this example, the IP packet is a DHCPOFFER packet, and thus its destination is a broadcast address (255. 255. 255. 255), which does not match the IP address of the access point 2. Consequently, the controller 22 extracts the destination port number of the received IP packet (Step S34 in FIG. 5) and checks whether the extracted port number is “68”(Step S35 in FIG. 5).

“68” is a port number reserved for the DHCP client. As the destination port number of the. DHCPOFFER packet is “68”, the received IP packet is passed to the wireless communications section 21 (Step S38 in FIG. 5). Upon receiving the IP packet, the wireless communications section 21 modulates it and sends it to the terminal 1 (Step S39 in FIG. 5).

Then, the terminal 1 sends out the packet (DHCPREQUEST) A3. The operations performed when the access point 2 receives the packet A3 are the same as the operations performed when it receives the packet A1 is received.

Then, the DHCP server sends out the packet (DHCPACK) A4. The operations performed when the access point 2 receives the packet A4 are the same as the operations performed when it receives the packet A2 is received.

The operations performed when the access point 2 receives the packet A5 will be described with reference to FIGS. 3 and 4. The packet A5 is the one sent to a target node in the wired segment by the terminal 1 which has not been authenticated. It is assumed that the destination IP address of the packet is IP₂ and that its destination port number does not match any of the following: “67”, “80”, and “8080”.

The wireless communications section 21 demodulates the signal received from the terminal 1 and passes the IP packet stored as data in the resulting IEEE 802.11 frame to the controller 22 (Step Si in FIG. 3). Upon receiving the IP packet, the controller 22 extracts the destination IP address (Step S2 in FIG. 3) from the received IP packet and checks whether the destination IP address matches the IP address assigned to the local equipment (the access point 2) (Step S3 in FIG. 3).

In this example, the destination IP address is IP₂, which does not match the IP address assigned to the access point 2. Consequently, the controller 22 extracts the destination port number of the IP packet (Step S4 in FIG. 3) and checks whether the extracted destination port number is “67” (Step S5 in FIG. 3). Since destination port number of this packet is not “67”, the controller 22 extracts the source IP address of the received IP packet and checks whether this IP address is contained in the authentication table of the authentication check result storage means 23 (Step S6 in FIG. 3). For example, an authentication table 23a shown in FIG. 8 is stored in the authentication check result storage means 23. The authentication table 23a stores the IP addresses which have gone through an authentication check together with the results of the check (OK/NG).

If a terminal is unauthenticated, its IP address does not exist in the authentication table 23a (Step S7 in FIG. 3). Therefore, the controller 22 checks whether the destination port number is “80” or “8080” (Step S14 in FIG. 4). “80” is a port number reserved for HTTP while “8080” is a port number generally used by HTTP Proxy. Since this packet matches neither, it is eventually discarded (Step S13 in FIG. 3).

Now, the operations performed when the access point 2 receives the packet A6 will be described with reference to FIGS. 3 and 4. The packet A6 has a destination IP address of IP₁ which has been assigned to the access point 2 and a destination port number of “80”. Furthermore, it contains the HTTP GET method.

The wireless communications section 21 demodulates the signal received from the terminal 1 and passes the IP packet stored as data in the resulting IEEE 802.11 frame to the controller 22 (Step S1 in FIG. 3). Upon receiving the IP packet, the controller 22 extracts the destination IP address (Step S2 in FIG. 3) from the received IP packet and checks whether the destination IP address matches the IP address assigned to the local equipment (the access point 2) (Step S3 in FIG. 3).

In this example, since the destination IP address matches the IP address (IP₁) assigned to the access point 2, the controller 22 checks whether the destination port number of the received IP packet is “80” or “8080” (Step S14 in FIG. 4). In this example, since the destination port number is “80”, the controller 22 checks whether the HTTP GET method is contained in the packet (Step S15 in FIG. 4).

In this example, since the GET method is contained, the controller 22 asks the CGI execution means 24 to execute the authentication CGI program (Step S20 in FIG. 4). The CGI execution means 24 gets the authentication CGI program from the authentication CGI storage means 25 and executes it. The CGI program is designed to generate an HTML document according to conditions. In this example, since the terminal has not been authenticated, the program generates an HTML document for entering a user ID and password.

For the terminal 1, the CGI execution means 24 establishes the HTML document which is the output of the CGI program, as a response form with respect to the HTTP GET method, stores a response to the HTTP GET method in a data portion of an IP packet addressed to the terminal 1, and passes the IP packet to the wireless communications section 21 (Step S21 in FIG. 4). The wireless communications section 21 demodulates the received packet and sends it to the terminal 1 (Step S22 in FIG. 4). This packet corresponds to the packet A7 in FIG. 7.

Although the packet A6 is addressed to the access point 2 (IP₁), description will be given about a case in which the access point 2 receives a packet addressed to a node different from the access point. In this case, the flow up to Step S3 is the same as in the case of the packet A6 described above. Since the destination is different from the IP address assigned to the access point 2, the controller 22 extracts the destination port number from the received IP packet (Step S4 in FIG. 3) and checks whether the extracted destination port number is “67” (Step S5 in FIG. 3).

In this example, since the destination port number is “80”, the controller 22 extracts the source IP address from the received packet and checks whether the IP address is stored in the authentication table 23a of the authentication check result storage means 23 (Step S6 in FIG. 3). In this case, since the terminal has not been authenticated, the authentication table 23a does not contain the source IP address of the received packet (Step S7 in FIG. 3). Consequently, the controller 22 checks whether the destination port number is “80” or “8080” (Step S14 in FIG. 4). In this example, since the destination port number is “80”, the controller 22 checks whether the HTTP GET method is contained in the received packet (Step S15 in FIG. 4). Subsequent operations are the same as those for the reception of the packet A6.

Now, the operations performed when the access point 2 receives the packet A8 will be described with reference to FIGS. 3 and 4. It is assumed that the packet A8 has a destination IP address of IP, and a destination port number of “80” and contains the HTTP POST method. It is also assumed that the packet A8 contains a user ID and password in its body. The operations up to Step S15 are the same as those performed when the access point 2 receives the packet A6.

The controller 22 checks whether the received packet contains the HTTP GET method (Step S15 in FIG. 4). In this example, since the HTTP POST method is contained, the controller 22 checks whether a user ID and password have been sent by the HTTP POST method (Step S16 in FIG. 4). Since the user ID and password are contained, the controller 22 passes the acquired user ID and password to the authentication client 26 and entrust it with authentication check (Step S17 in FIG. 4).

The authentication client 26 generates an authentication request packet to be sent to the authentication server 3 and passes it to the wired communications section 27 (Step S18 in FIG. 4). The wired communications section 27 processes the received packet and sends it to the wire communications medium 100 (Step S19 in FIG. 4). This packet corresponds to the packet A9 in FIG. 7.

Now, the operations performed when the access point 2 receives the packet A10 will be described with reference to FIGS. 5 and 6. It is assumed that the packet A10 has a destination IP address of IP₁, that the destination port number of the packet A10 is the source port number from which the authentication client 26 sent the authentication request, and that the packet A10 contains data about “access permission”.

First, when a signal is received in the wired communications section 27, the access point 2 extracts an Ethernet frame by processing the signal and passes the IP packet stored as Ethernet frame data to the controller 22 (Step S31 in FIG. 5). The controller 22 extracts the destination IP address (Step S32 in FIG. 5) from the received packet and checks whether the destination IP address matches the IP address (IP₁) assigned to the local equipment (the access point 2) (Step S33 in FIG. 5). In this example, the destination IP address of the received IP packet is IP₁, which means that they match.

The controller 22 checks whether the destination port number is the port number of the authentication client 26 (Step S41 in FIG. 6). If it is not, the controller 22 processes the received IP packet according to the function [e.g., SNMP (Simple Network Management Protocol) server, telnet server, etc.] provided by the access point 2 (Step S49 in FIG. 6).

In this example, since the destination port number matches the port number of the authentication client 26, the controller 22 passes the received IP packet to the authentication client 26 (Step S42 in FIG. 6). The authentication client 26 checks whether the received packet contains “access permission” or “access denial” information (Step S43 in FIG. 5). If the packet is irrelevant to “access permission” and “access denial,” the authentication client discards it (Step S40 in FIG. 5).

In this example, since the received packet contains access information, the authentication client 26 checks whether it contains “access permission” information (Step S44 in FIG. 6). Since the packet contains “access permission” information, the controller 22 records the IP address of the terminal which is permitted to access and information to the effect that access is permitted in the authentication check result storage means 23 (Step S45 in FIG. 6).

The authentication client 26 notifies the CGI execution means 24 that access has been permitted (Step S46 in FIG. 6). Upon being notified of the access permission, the CGI execution means 24 creates an HTML document about the “access permission,” generates a response to the HTTP POST method by including the document in the body, and sends an IP packet containing the response as data, to the wireless communications section 21 (Step S47 in FIG. 6). The wireless communications section 21 modulates received IP packet and sends it to the terminal 1 (Step S48 in FIG. 6). The transmitted packet corresponds to the packet All in FIG. 7.

A case in which the packet A10 contains “access permission” information has been described above, and now a case in which the packet A10 contains “access denial” information will be described with reference to FIGS. 5 and 6. In this case, the flow up to Step S44 is the same as in the case of “access permission” described above.

In this example, since the result of authentication check by the authentication server 3 is “access denial,” the authentication client 26 records the IP address of the terminal 1 and information to the effect that access is denied in the authentication check result storage means 23 (Step S50 in FIG. 6).

The authentication client 26 notifies the CGI execution means 24 of the access denial(Step S51 in FIG. 6). Upon receiving notification about the access denial, the CGI execution means 24 creates an HTML document about the “access denial,” generates a response to the HTTP POST method by including the document in the body, and sends an IP packet containing the response as data, to the wireless communications section 21 (Step S52 in FIG. 6). The wireless communications section 21 modulates the received IP packet and sends it to the terminal 1 (Step S53 in FIG. 6).

Now, the operations performed when the access point 2 receives the packet A12 will be described with reference to FIG. 3. The packet A12 has a destination IP address of IP₂ and a destination port number other than “67.”

First, the wireless communications section 21 demodulates the signal received from the terminal 1 and passes the IP packet stored as data in the resulting IEEE 802.11 frame to the controller 22 (Step SI in FIG. 3). Upon receiving the IP packet, the controller 22 extracts the destination IP address (Step S2 in FIG. 3) from the received IP packet and checks whether the destination IP address matches the IP address assigned to the access point 2 (Step S3 in FIG. 3).

In this example, since the destination IP address is IP₂. the controller 22 extracts the destination port number of the received IP packet (Step S4 in FIG. 3) and checks whether the extracted destination port number is “67” (Step S5 in FIG. 3). Since the destination port number of this packet is not “67,” the controller 22 extracts the source IP address of the received IP packet and checks whether this IP address is contained in the authentication table 23a of the authentication check result storage means 23 (Step S6 in FIG. 3).

In this example, the terminal 1 has already been authenticated, so the authentication table 23a contains the IP address of the terminal 1 (Step S7 in FIG. 3). Thus, the controller 22 checks whether the terminal which has the source IP address (IP₀) of the received packet is permitted to access to the wired segment (Step S8 in FIG. 3). As the IP address of IP₀ is permitted to access to the wired segment, the wired communications section 27 processes the received packet and sends it to the wire communications medium 100 (Step S10 in FIG. 3).

Now, the operations performed when the access point 2 receives the packet A13 shown in FIG. 7 will be described with reference to FIG. 5. The packet A13 has a destination IP address of IP₀, which is the IP address of the terminal 1. Its destination port number is other than 68.

When a signal is received in the wired communications section 27, the access point 2 extracts an Ethernet frame by processing the signal and passes the IP packet stored as Ethernet frame data to the controller 22 (Step S31 in FIG. 5). The controller 22 extracts the destination IP address (Step S32 in FIG. 5) from the received packet and checks whether the destination IP address matches the IP address (IP₁) assigned to the local equipment (the access point 2) (Step S33 in FIG. 5).

In this example, since the destination IP address of the received IP packet is IP₀, the controller 22 extracts the destination port number of the received IP packet (Step S34 in FIG. 5) and checks whether the extracted destination port number is “68” (Step S35 in FIG. 5). Since the destination port number of this packet is not “68,” the controller 22 checks with reference to the authentication table 23a of the authentication check result storage means 23 whether the IP address of the received IP packet is contained in the authentication table 23a and whether access to the wired segment is permitted (Step S36 in FIG. 5). As it turns out that access is permitted (Step S37 in FIG. 5), the received IP packet is passed to the wireless communications section 21 (Step S38 in FIG. 5), which then modulates the received IP packet and sends it to the terminal 1 (Step S39 in FIG. 5).

Through the operations described above, the access point 2 makes the controller 22 block all the packets to and from any unauthenticated terminal which is not permitted to access except the packet needed for the DHCP server to acquire an IP address.

However, if an IP packet containing the HTTP GET method is received from the terminal 1, the authentication page is returned in response regardless of whether the IP packet is addressed to the access point 2. Subsequently, if the terminal 1 sends a user ID and password by the HTTP POST method, the authentication server 3 is asked whether the user is permitted to access. If it turns out that the user is permitted to access, the controller 22 allows the passage of packets to and from that terminal 1 instead of blocking them.

Thus, in a wireless communications environment such as a wireless LAN, this embodiment makes it possible to implement safe authentication using a password which the user can specify freely. Although MAC address-based authentication schemes which are used generally at present are not safe because any third party can find out MAC addresses and falsify the MAC address in transmitted packets, the method according to this embodiment is safe as long as the user does not disclose his/her password to others.

Also, this embodiment allows the result of authentication check to be returned to the terminal 1. With WEP (Wired Equivalent Privacy)-based authentication, denial of access is indicated indistinctly as an inability to communicate. With this embodiment, however, the access point 2 can explicitly declare “access denied” because even a packet from a terminal which is not permitted to access reaches the access point 2.

Besides, by incorporating into the access point 2 an HTTP protocol interpreter and the CGI execution means 24 which generates HTML documents, it is possible to use a popular WEB browser for user ID and password entry. Thus, a user authentication system can be implemented with an interface easy to use for general users.

Furthermore, when the HTTP GET method is received from an unauthenticated user, the access point 2 returns an HTML document for authentication instead of the HTML document requested by the user. Thus, when using the WEB browser, the user does not need to be aware of whether he/she has been authenticated.

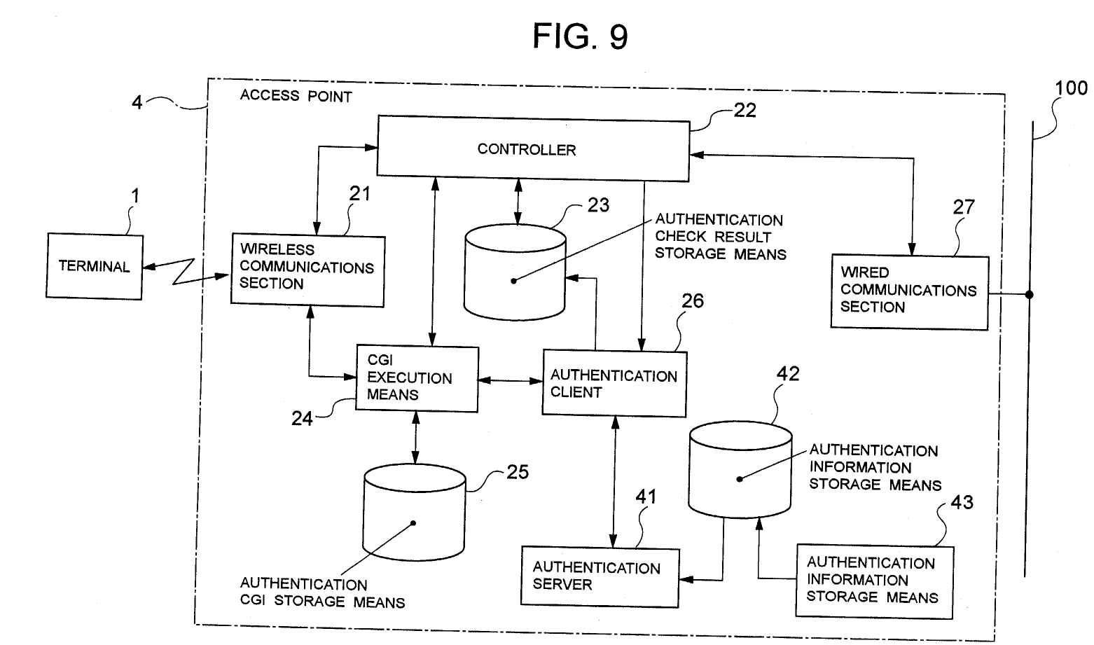

FIG. 9 is a block diagram showing the configuration of an access point according to another embodiment of the present invention. In FIG. 9, the access point 4 according to the second embodiment of the present invention is configured similarly to the access point 2 according to the first embodiment of the present invention shown in FIG. 2, except that it comprises an authentication server 41, authentication information storage means 42, and authentication information input means 43. The same components are denoted by the same reference numerals. Thus, the second embodiment is configured such that the authentication server 3 of the first embodiment has been moved into the access point 4.

The operation of this embodiment is basically the same as that of the first embodiment, the only difference being that according to this embodiment, the authentication client 26 exchanges authentication requests and authentication check results with the authentication server 41, whereas according to the first embodiment, the authentication client 26 exchanges authentication requests and authentication check results with the authentication server 3 via the wired communications section 27 and wire communications medium 100.

The authentication server 41 determines access permission or denial by referring to the authentication information storage means 42 incorporated in the access point 4. Thus, necessary information must be stored in the authentication information storage means 42 in advance. For that, a manager of the wired segment enters the information necessary for authentication in the authentication information storage means 42 using the authentication information input means 43.

In this way, according to this embodiment, since authentication server functions are incorporated in the access point 4, there is no need for an access point installer to newly install an authentication server 3 such as the one used in the first embodiment of the present invention. Thus, this embodiment saves the trouble of installing an authentication server 3 and involves lower costs than the use of a large-scale server.

As described above, in a network containing an access point which serves as an entrance to a wired network for terminals which use a wireless network, the present invention can implement a safer authentication scheme with an interface easy to use for general users, by providing the access point with the capabilities to determine whether a terminal is permitted to access to the wired network when a packet is received from that terminal; transmit the packet to the wired network if it is determined that the access is permitted; discard the packet if it is determined that the access is not permitted; generate an HTML document for user identification information and password entry and transmit it to the terminal when a request for an authentication page is received from the terminal.

What is claimed is:

1. A user authentication system containing an access point which serves as an entrance to a wired network for terminals which use a wireless network, wherein said access point comprises: determining means for determining whether one of said terminals is permitted to access to said wired network when a packet is received from said terminal; means for transmitting the packet to said wired network if said determining means determines that said access is permitted; means for discarding the packet if said determining means determines that said access is not permitted; and means for generating an HTML (Hypertext Markup Language) document for user identification information and password entry and transmitting it to said terminal when a request for an authentication page is received from said terminal.

2. The user authentication system according to claim 1 comprising:
an authentication server for checking whether access to said wired network is permitted,
wherein said determining means asks said authentication server via said wired network to check whether said terminal is permitted to access to said wired network.

3. The user authentication system according to claim 1 wherein:
said access point contains an authentication server for checking whether access to said wired network is permitted;
said determining means asks said authentication server to check whether said terminal is permitted to access to said wired network.

4. The user authentication system according to claim 1 wherein said access point contains means for generating an HTML document which contains the result of said check by said authentication server and transmitting it to said terminal.

5. The user authentication system according to claim 1 wherein said means for generating an HTML document executes an authentication program written in a scripting language.

6. A user authentication method for a network containing an access point which serves as an entrance to a wired network for terminals which use a wireless network, comprising, in said access point: a step of determining whether one of said terminals is permitted to access to said wired network when a packet is received from said terminal; a step of transmitting the packet to said wired network if it is determined that said access is permitted; a step of discarding the packet if it is determined that said access is not permitted; and a step of generating an HTML (Hypertext Markup Language) document for user identification information and password entry and transmitting it to said terminal when a request for an authentication page is received from said terminal.

7. The user authentication method according to claim 6 wherein:
said network contains an authentication server for checking whether access to said wired network is permitted; and
said step of determining whether access is permitted comprises asking said authentication server via said wired network to check whether said terminal is permitted to access to said wired network.

8. The user authentication method according to claim 6 wherein:
said access point contains an authentication server for checking whether access to said wired network is permitted;
said step of determining whether access is permitted comprises asking said authentication server to check whether said terminal is permitted to access to said wired network.

9. The user authentication method according to claim 6 wherein said access point contains a step of generating an HTML document which contains the result of said check by said authentication server and transmitting it to said terminal.

10. The user authentication method according to claim 6 wherein said step of generating an HTML document comprises executing an authentication program written in a scripting language.
